(19) United States
(12) Patent Application Publication
(10) Pub. No.: US 2026/0085721 A1
(43) Pub. Date: Mar. 26, 2026

(54) MOTOR BEARING WITH ANISOTROPIC SUPPORT STIFFNESS

(71) Applicant: Schlumberger Technology Corporation, Sugar Land, TX (US)

(72) Inventor: Pradeep Mahadevan, Singapore (SG)

(21) Appl. No.: 19/339,768

(22) Filed: Sep. 25, 2025

Related U.S. Application Data
(60) Provisional application No. 63/698,977, filed on Sep. 25, 2024.

(51) Int. Cl. F16C 33/24; F16C 17/02; F16C 35/02; F16C 35/10

(52) U.S. Cl. CPC F16C 33/24; F16C 17/02; F16C 35/02; F16C 35/10; F16C 2360/00; F16C 2380/27

(57) ABSTRACT

A bearing has a bearing body with a bore extending therethrough, a bushing positioned in the bore and supported by the bearing body, the bearing body providing a first support stiffness to support the bushing, and a plurality of biasing members positioned in the bearing body, the plurality of biasing members being deformable to support the bushing with a second support stiffness that is different from the first support stiffness.

### CROSS-REFERENCES TO RELATED APPLICATIONS

The present application claims the benefit of United States Provisional Application No. 63/698977 filed Sep. 25, 2024, the entirety of which is incorporated by reference herein and should be considered part of this specification.

### FIELD

The present disclosure relates to motor bearings, and more specifically, to a motor bearing for providing anisotropic support stiffness.

### BACKGROUND

Electrical submersible pumps (ESPs) are often used in oil fields to lift crude oil from an underground reservoir to the surface of the well. For example, ESPs typically include one or more electric motors that provide rotational power to a pump via a shaft. The shaft is supported in the motor by one or more bearings (e.g., journal bearings or oil-lubricated hydrodynamic bearings).

### SUMMARY

In one independent aspect, a bearing includes: a bearing body having a bore extending therethrough; a bushing positioned in the bore and supported by the bearing body, the bearing body providing a first support stiffness to support the bushing; and a plurality of biasing members positioned in the bearing body, the plurality of biasing members being deformable to support the bushing with a second support stiffness that is different from the first support stiffness.

In some aspects, the plurality of biasing members supports the bushing with respect to a first axis, the bearing body supports the bushing with respect to a second axis, and the first axis and the second axis are oriented non-parallel to one another.

In some aspects, the bearing further includes a relief track positioned on the bearing body adjacent to the bore, and at least one of the plurality of biasing members is in contact with the bushing proximate to the relief track.

In some aspects, the plurality of biasing members includes a plurality of wave springs, wherein each of the plurality of wave springs is selectively deformable in a radial direction with respect to the bushing.

In some aspects, the plurality of biasing members includes a plurality of blocks composed of an elastomer, and each of the plurality of blocks is configured to retain an elastic property at a maximum expected temperature of the bearing.

In some aspects, the plurality of biasing members includes a plurality of rolled spring pins, and each of the plurality of rolled spring pins is deformable with respect to a cross section thereof.

In some aspects, the bearing further includes one or more keyways formed in the bearing body, wherein the one or more keyways are configured to engage with a stator to couple the bearing with the stator.

In another independent aspect, a bearing housing is provided for supporting a bushing. The bearing housing includes a bearing body, a first plurality of biasing members, and a second plurality of biasing members. The bearing body includes a bore extending therethrough along a bore axis, and the bore is configured to receive the bushing. The first plurality of biasing members is configured to support the bushing with a first support stiffness while the bushing is disposed in the bore. The first plurality of biasing members includes a first biasing member and a second biasing member positioned on opposite sides of the bearing housing from one another. A first support axis extends between the first biasing member and the second biasing member, and the first support axis is oriented transversely with respect to the bore axis. The first biasing member and the second biasing member are each configured to exert a force on the bushing that is directed radially inward with respect to the bore axis. The second plurality of biasing members is configured to support the bushing with a second support stiffness greater than the first support stiffness while the bushing is disposed in the bore. The second plurality of biasing members includes a third biasing member and a fourth biasing member positioned on opposite sides of the bearing housing from one another. A second support axis extends between the third biasing member and the fourth biasing member, and the second support axis is oriented transversely with respect to the bore axis and non-parallel to the first axis. The third biasing member and the fourth biasing member are each configured to exert a force on the bushing that is directed radially inward with respect to the bore axis.

In some aspects, the first plurality of biasing members includes a first quantity of biasing members, the second plurality of biasing members includes a second quantity of biasing members that is greater than the first quantity of biasing members.

In some aspects, the first plurality of biasing members includes a first quantity of biasing members, the second plurality of biasing members includes a second quantity of biasing members equal to the first quantity of biasing members, each of the first plurality of biasing members having a different stiffness than each of the second plurality of biasing members.

In some aspects, the first axis and the second axis are oriented substantially perpendicular to one another.

In some aspects, the first biasing member and the second biasing member are each positioned adjacent to the bore.

In some aspects, the first support stiffness is about 1.5 times greater than the second support stiffness.

In yet another independent aspect, an electronic submersible pump system includes: a pump configured to displace a fluid; a motor operably coupled to the pump to provide rotational power to the pump, the motor having an elongated motor casing, a stator positioned in the elongated motor casing, a rotor configured to rotate relative to the stator, and a shaft coupled to the rotor, the shaft being positioned at least partially in the elongated motor casing; a bearing disposed in the elongated motor casing, the bearing configured to support the shaft as the shaft rotates relative to the stator, the bearing having: a bearing body coupled to the stator, a bushing disposed in the bearing body, and a cage disposed in the bearing body, the cage including a plurality of notches that form at least one region of reduced stiffness of the cage, the cage supporting the bushing with a first support stiffness oriented along a first axis and a second support stiffness oriented along a second axis, the second support stiffness being less than the first support stiffness.

In some aspects, the at least one region of reduced stiffness includes a first region of reduced stiffness and a second region of reduced stiffness, and the first region of reduced stiffness and the second region of reduced stiffness each provide support for the bearing along the second axis.

In some aspects, the first region of reduced stiffness and the second region of reduced stiffness are positioned on opposing sides of the cage from one another.

In some aspects, the cage includes an inner diameter and an outer diameter, and each notch from the plurality of notches extends from the inner diameter toward the outer diameter.

In some aspects, the bushing is positioned adjacent to the inner diameter.

In some aspects, the first axis and the second axis are oriented transversely relative to the longitudinal axis of the shaft.

In some aspects, the electronic submersible pump system further includes a sleeve that is disposed in the bushing and coupled with the shaft, and the sleeve is configured to rotate about the longitudinal axis with the shaft.

Other aspects will become apparent by consideration of the detailed description and accompanying drawings.

### BRIEF DESCRIPTION OF THE DRAWINGS

FIG. 1 is a perspective view of a motor with a housing of the motor partially hidden.

FIG. 2A is a side cross-section view of the motor of FIG. 1.

FIG. 2B is a partial cross-section view of the motor of FIG. 1 taken from region A of FIG. 2A.

FIG. 3A is a top plan view of a support bearing, according to an embodiment.

FIG. 3B is a perspective view of the support bearing of FIG. 3A with a shaft disposed therein.

FIG. 3C is an exploded view of the support bearing and the shaft of FIG. 3B.

FIG. 4A is a top plan view of a support bearing, according to another embodiment.

FIG. 4B is a top plan view of a support bearing, according to another embodiment.

FIG. 4C is a top plan view of a support bearing, according to another embodiment.

FIG. 5 is a top plan view of a support bearing, according to another embodiment.

FIG. 6 is a top plan view of a support bearing, according to another embodiment.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Relative terminology, such as, for example, “about,” “approximately,” “substantially,” and the like, used in connection with a quantity or condition would be understood by those of ordinary skill to be inclusive of the stated value and has the meaning dictated by the context (for example, the term includes at least the degree of error associated with the measurement accuracy, tolerances (for example, manufacturing, assembly, use, and the like) associated with the particular value, and the like). Such terminology should also be considered as disclosing the range defined by the absolute values of the two endpoints. For example, the expression “from about 2 to about 4” also discloses the range “from 2 to 4.” The relative terminology may refer to plus or minus a percentage (for example, 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

In general, the present disclosure relates to bearings for addressing pump instability (e.g., in an ESP). Pump instability is particularly an issue for high speed motors where the oil whirl or oil whip causes sub-synchronous vibrations (i.e., vibrations occurring at frequencies less than the rotational frequency of the shaft). If unaddressed, pump instability caused by these sub-synchronous vibrations may render it difficult or impossible to operate an ESP at higher rotational speeds (i.e., rotational speeds above a threshold). Accordingly, the present disclosure relates to bearings that provide anisotropic support stiffnesses to help address or reduce pump instability.

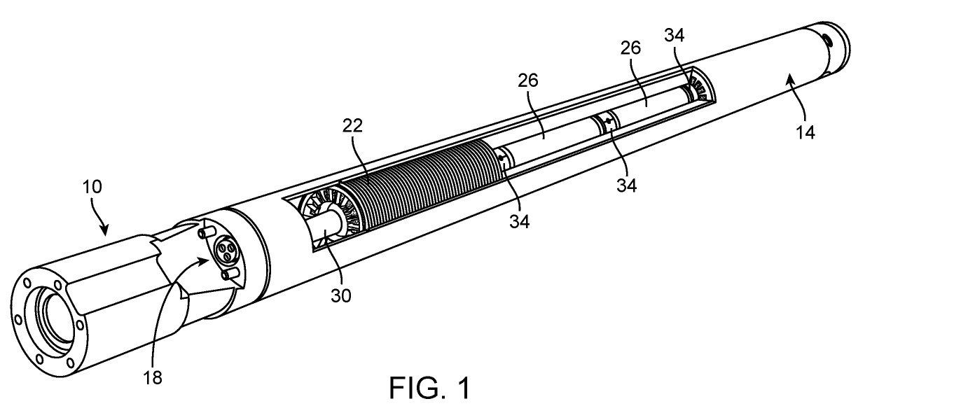

FIG. 1 illustrates a motor 10 for generating rotational power for an electric submersible pump (not illustrated). When the motor 10 is coupled to an electric submersible pump, the motor 10 may provide rotational power to a pump assembly (not illustrated) for displacing a fluid in a well.

In the illustrated embodiment, the motor 10 includes a motor housing or motor casing 14 (partially hidden in FIG. 1), motor lead electrodes 18, a stator 22, at least one rotor 26, a shaft 30, and at least one bearing 34. As will be described herein, the motor casing 14 may shield the components of the motor 10 from the surrounding environment (e.g., fluid in a well). The motor lead electrodes 18 may receive an electrical current for powering or controlling the motor 10 and may be disposed on the motor casing 14. The stator 22 may be in electrical communication with the motor lead electrodes 18 and may generate a magnetic flux to rotate the at least one rotor 26 relative to the motor casing 14. The shaft 30 may transfer rotational movement from the at least one rotor 26 to a pump coupled with the motor 10. The at least one bearing 34 may be coupled to the stator 22 and may support the shaft 30 as the shaft 30 rotates relative to the stator 22. However, other configurations for the motor 10 are also contemplated and considered within the scope of the present disclosure.

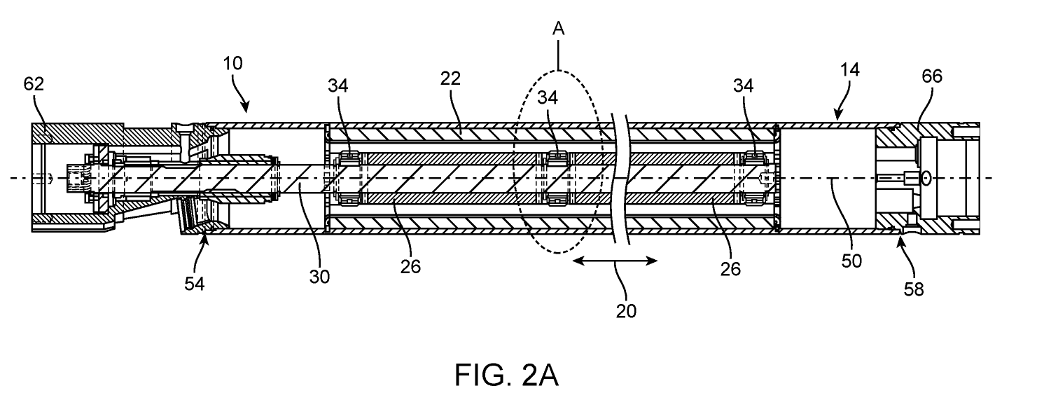

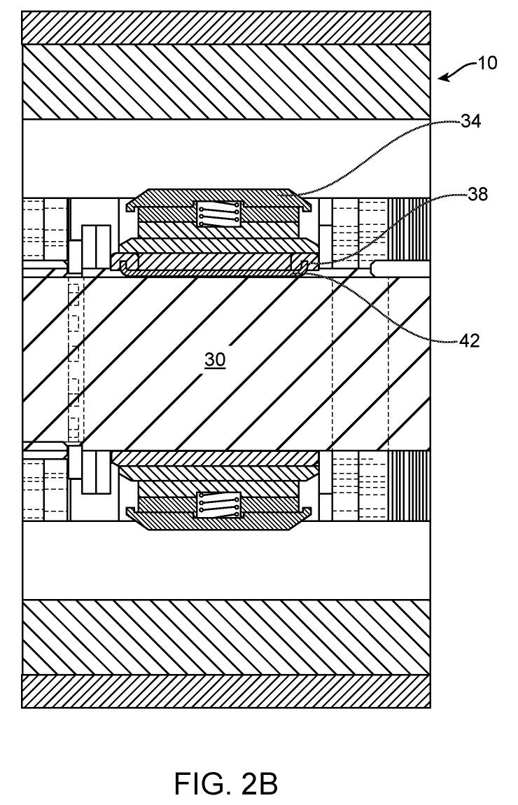

As best illustrated in FIG. 2A, the motor casing 14 may be a hollow and elongated structure that extends along an axis 50 from a first end 54 to a second end 58. The first end 54 may be engaged with a motor head 62 that is sized and shaped to operably couple the motor 10 with an electric submersible pump (not illustrated). The second end 58 may be selectively couplable with either a motor base 66 or a second motor (not illustrated). When the second end 58 is coupled to a second motor, the motor 10 may operably engage with the second motor to generate a power, torque, and/or rotational speed that is greater than motor 10 is individually capable of generating.

The stator 22 may be coupled to the motor casing 14 and may generate a magnetic flux. For example, the stator 22 may include a plurality of motor windings that are arranged to form an assembly that is generally tubular-shaped. In addition, the stator 22 may be sized and shaped to allow for the at least one rotor 26 to be disposed therein, although in some other embodiments, the stator 22 may be disposed in the at least one rotor 26.

The at least one rotor 26 may be disposed proximate to the stator 22 and may be coupled to the shaft 30. In particular, the at least one rotor 26 may include a plurality of rotors that are spaced along a length of the shaft 30 and coupled to the shaft 30. In addition, the at least one rotor 26 may be in magnetic communication with the stator 22 and selectively rotatable about an axis. As a result, the at least one rotor 26 may rotate in response to a magnetic flux generated by the stator 22.

The shaft 30 may be coupled to the at least one rotor 26 and may transfer rotational power from the at least one rotor 26 to a pump coupled therewith. For example, the shaft 30 may be a rod or an elongated body that extends in a direction parallel to the axis 50 from the at least one rotor 26 toward the first end 54 of the motor casing 14. Further, the shaft 30 may be operably couplable with a pump proximate to the first end 54 of the motor casing 14. Thus, the shaft 30 may transfer rotational power from the at least one rotor 26 to a pump operably coupled to the motor 10.

The at least one bearing 34 may include a plurality of bearings that help prevent or reduce vibrations as the shaft 30 rotates relative to the motor casing 14. In particular, each of the at least one bearings 34 may be arranged along the length of the shaft 30, and each of the at least one bearings 34 may rotatably couple the shaft 30 with the motor casing 14. In some embodiments, each of the at least one bearings 34 may be a journal bearing or an oil-lubricated hydrodynamic bearing. Moreover, as will be described herein, each of the at least one bearings 34 may support the shaft 30 anisotropically. Stated another way, a support stiffness provided by the bearing is asymmetric—the support stiffness provided by the bearing in one radial direction relative to the axis of rotation of the shaft is different from a support stiffness provided by the bearing in another radial direction.

In FIG. 2B, the shaft 30 and one of the at least one bearings 34 are illustrated in further detail. As illustrated, the shaft 30 may be disposed in the bearing 34. In addition, a sleeve 38 may be positioned between the shaft 30 and the bearing 34. The sleeve 38 may help to reduce friction between the shaft 30 and the bearing 34 while the shaft 30 rotates relative to bearing 34. For example, the sleeve 38 may surround the shaft 30, and the sleeve 38 may be coupled with the shaft 30 via a key 42. As a result, the sleeve 38 may rotate with the shaft 30 to help reduce friction between the shaft 30 and the bearing 34.

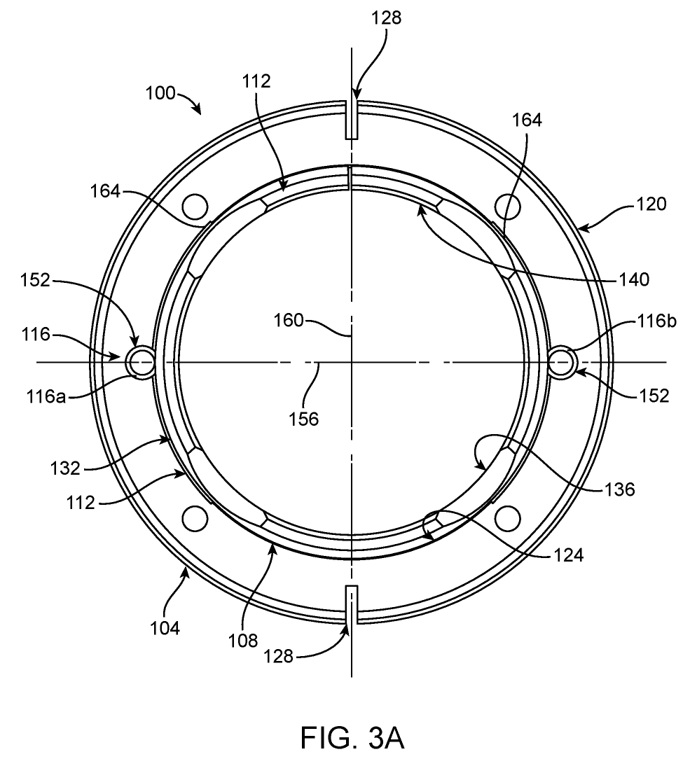

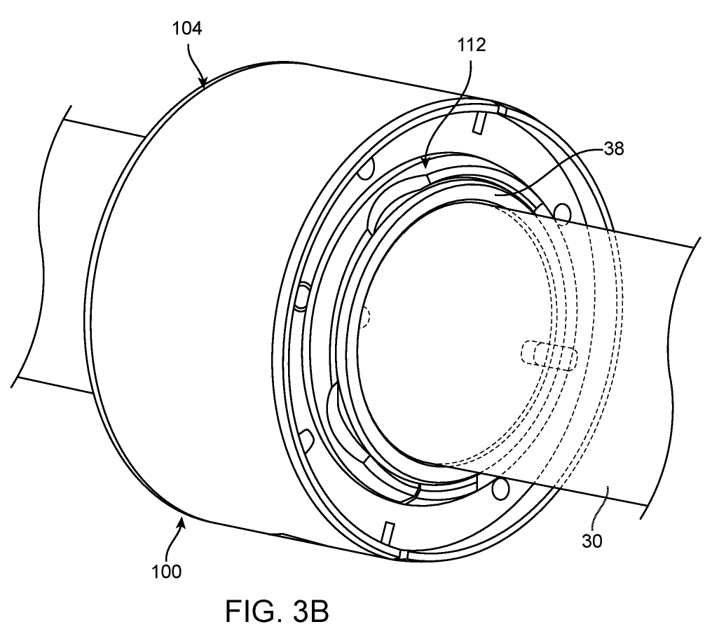

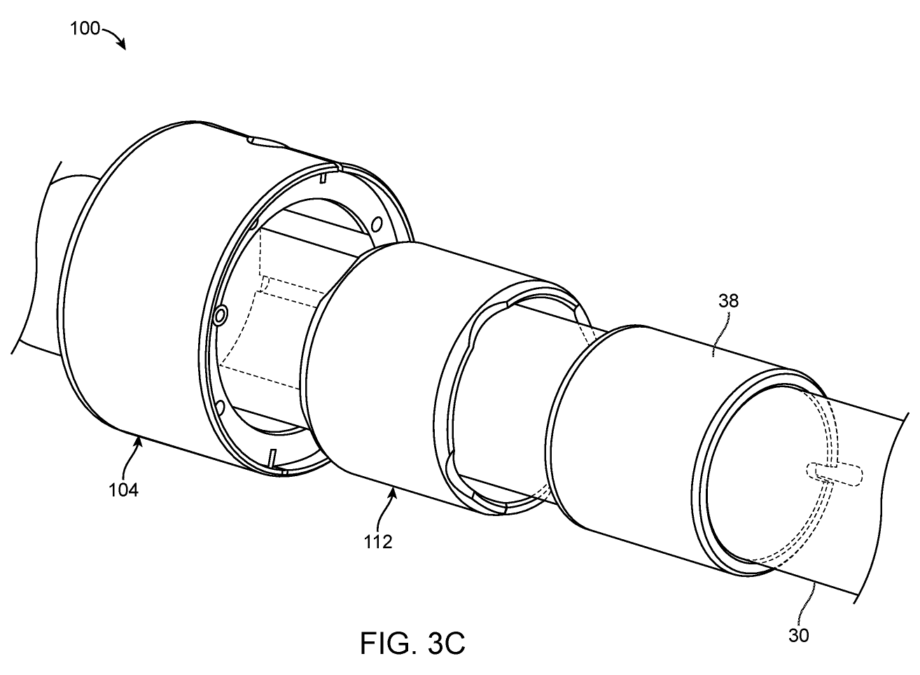

FIG. 3A illustrates an embodiment of a bearing 100 that supports a shaft 30 (see, e.g., FIG. 1) anisotropically and/or asymmetrically. As illustrated, the bearing 100 includes a bearing body 104 having a bore 108 extending therethrough, a bushing 112 disposed in the bore 108, and a plurality of support members 116.

As illustrated in FIG. 3A, the bearing body 104 may be a tubular-shaped housing that includes a bore extending along a bore axis and that couples the bearing 100 with the stator 22 (FIG. 2A). In the illustrated embodiment, the bore axis is substantially aligned with the axis 50. For example, the bearing body 104 may be formed of steel and may include a ring-shaped cross section defined by an outer bearing circumference 120 and an inner bearing circumference 124. The outer bearing circumference 120 may be sized and shaped to allow the bearing body 104 to be disposed in the stator 22. In addition, one or more slots or keyways 128 formed in the bearing body 104 proximate to the outer bearing circumference 120 may engage with the stator 22 when the bearing body 104 is disposed in the stator 22. The inner bearing circumference 124 may define the bore 108 and may be sized and shaped to allow the bushing 112 to be disposed in the bore 108.

The bushing 112 may support the shaft 30 as the shaft 30 rotates relative to the bearing body 104. For example, the bushing 112 may be a tubular-shaped structure formed of steel or bronze. The bushing 112 may include a ring-shaped portion that extends in a direction parallel to the axis 50 (FIG. 2A) and that is defined by an outer bushing circumference 132 and an inner bushing circumference 136. The outer bushing circumference 132 may be sized and shaped to allow the bushing 112 to be disposed in the bore 108 (e.g., via a press-fit). The inner bushing circumference 136 may be sized and shaped to allow the shaft 30 and the sleeve 38 to be disposed in the bushing 112. In addition, an inner bushing surface 140 defined by the inner bushing circumference 136 may be lined (e.g., with a polymer) to reduce friction between the bushing 112 and sleeve 38 as the sleeve 38 rotates relative to the bushing 112.

The plurality of support members 116 may include a first biasing member 116a and a second biasing member 116b that support the bushing 112 in the bearing body 104. For example, each of the first biasing member 116a and the second biasing member 116b may be a rolled spring pin. As used herein, a rolled spring pin may be understood to be a component that is formed into an elongated body where a cross section of the elongated body is selectively deformable when a force is applied to the spring pin. In addition, each of the first biasing member 116a and the second biasing member 116b may be disposed in grooves 152 positioned adjacent to the bore 108. Each of the grooves 152 may be formed in the bearing body 104, although in some other embodiments, each of the grooves 152 may be formed in bushing 112 or partially in both of the bearing body 104 and the bushing 112. As a result, each of the first biasing member 116a and the second biasing member 116b may be deformed by the bushing 112. Further, the first biasing member 116a and the second biasing member 116b may apply a force to the bushing 112 in response to being deformed. The force applied by the first biasing member 116a and the second biasing member 116b may help to support the bushing 112 in the bearing body 104.

In particular, the first biasing member 116a and the second biasing member 116b may support the bushing 112 along a first support axis 156 that is oriented transversely relative to the bore axis. For example, the first biasing member 116a and the second biasing member 116b may be positioned on opposing sides of the bore 108, and the first support axis 156 extends between the first biasing member 116a and the second biasing member 116b. Accordingly, the first biasing member 116a and the second biasing member 116b may be in contact with opposing sides of the bushing 112. The contact between the bushing 112 and the biasing members 116a, 116b may cause the first biasing member 116a and the second biasing member 116b to deform in a direction parallel to the first axis 156. As a result of the deformation, the first biasing member 116a and the second biasing member 116b may exert forces on the bushing 112 in a direction parallel to the first axis 156 (e.g., directed radially inward with respect to the bushing 112). In addition, the forces applied by the first biasing member 116a and the second biasing member 116b may be oriented opposite to one another. Accordingly, the first biasing member 116a and the second biasing member 116b may support the bushing 112 along the first axis 156.

As further illustrated in FIG. 3A, the bearing body 104 may support the bushing 112 along a second support axis 160 so that the bushing 112 is supported asymmetrically or anisotropically. For example, one or more relief tracks 164 may be formed in the bearing body 104 adjacent to the bore 108 and proximate to the plurality of support members 116. The one or more relief tracks 164 may be sized and shaped to allow the plurality of support members 116 to make contact with the bushing 112 proximate to the one or more relief tracks 164 and to allow the bearing body 104 to make contact with the bushing 112 proximate to the second axis 160. As a result, the bearing body 104 may make contact with the bushing 112 to support the bushing 112 along the second axis 160 while the plurality of support members 116 may make contact with the bushing 112 to support the bushing 112 along the first axis 156. The second axis 160 may be oriented non-parallel or perpendicular to the first axis 156, although other orientations are also contemplated. Proximate to each of the positions where the bearing body 104 is in contact with the bushing 112, the bearing body 104 may apply forces to the bushing 112. The forces applied by the bearing body 104 may be oriented opposite to one another and radially inward with respect to the bushing 112. In addition, the bearing body 104 may apply forces that are greater than or less than the forces applied by the plurality of support members 116. As a result, the bearing body 104 may support the bushing 112 with a support stiffness that is greater than or less than the support stiffness provided by the plurality of support members 116. Thus, the contact between the bushing 112 and the bearing body 104 may support the bushing 112 anisotropically. Further, the contact between the bearing body 104 and the bushing 112 may help to induce a suitable hoop stress in the bushing 112.

Referring to FIGS. 3B and 3C, the shaft 30 and the sleeve 38 may be disposed in the bushing 112 when the bearing 100 is positioned in the motor 10 (FIG. 1). For example, the sleeve 38 may be positioned adjacent to the bushing 112, and the shaft 30 may be disposed in the sleeve 38. As a result, the shaft 30 and the sleeve 38 may be supported by the bushing 112. In addition, because the bushing 112 is supported anisotropically, the bushing 112 may support the sleeve 38 with an anisotropic support stiffness. Accordingly, the shaft 30 and the sleeve 38 may receive anisotropic support as the shaft 30 and the sleeve 38 rotate relative to the bushing 112. However, it is to be understood that other suitable embodiments of the bearing 100 may not include a sleeve 38. In such embodiments, the shaft 30 may be positioned directly adjacent to the bushing 112, and the shaft 30 may be supported anisotropically by the bushing 112.

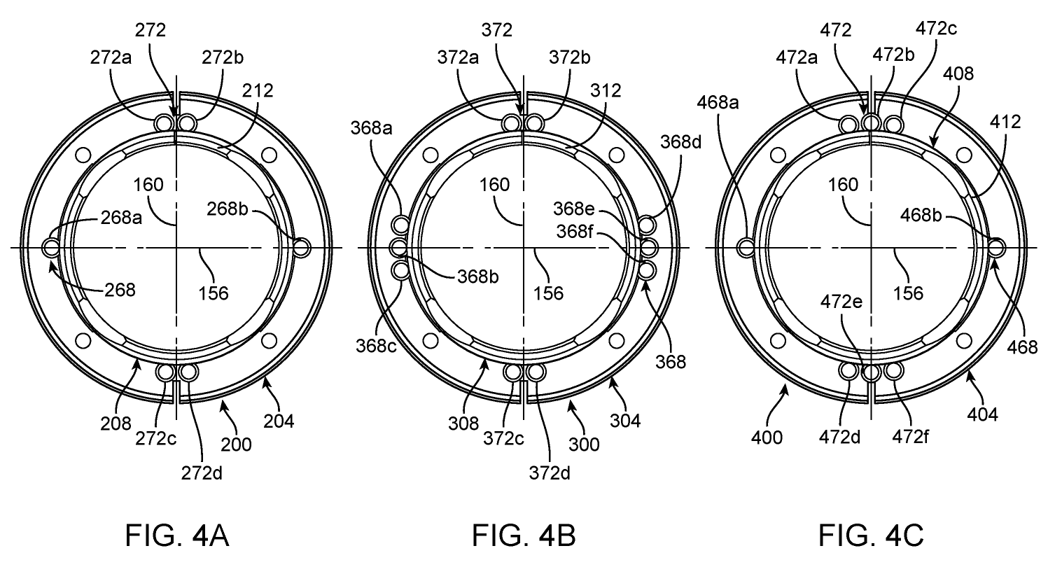

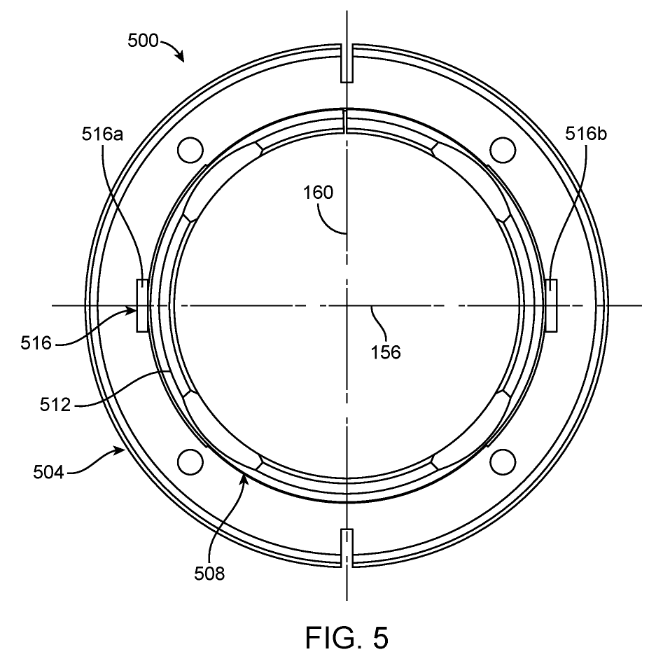

FIG. 4A illustrates another embodiment of a bearing 200. The bearing 200 is similar to the bearing 100 described above with respect to FIG. 3A, and similar features are identified with similar reference numbers, plus 100. For example, the bearing 200 may include a bearing body 204, a bore 208 formed in the bearing body 204, and a bushing 212 disposed in the bore 208.

However, in contrast to the bearing 100, the bearing 200 includes a first plurality of support members 268 and a second plurality of support members 272 that each support the bushing 212 in the bearing body 204. The first plurality of support members 268 may support the bushing 212 along the first axis 156, and the second plurality of support members 272 may support the bushing 212 along the second axis 160. The first axis 156 and the second axis 160 may be oriented non-parallel and perpendicular to one another, although other orientations are contemplated.

For example. the first plurality of support members 268 may include a first biasing member 268a and a second biasing member 268b positioned on opposing sides of the bushing 212 from one another with respect to the first axis 156. The second plurality of support members 272 may include a third biasing member 272a, a fourth biasing member 272b, a fifth biasing member 272c, and a sixth biasing member 272d. The third biasing member 272a and the fourth biasing member 272b may be positioned on an opposing side of the bushing 212 with respect to the second axis 160 from the fifth biasing member 272c and the sixth biasing member 272d. Thus, the first plurality of support members 268 may support the bushing 212 along the first axis 156, and the second plurality of support members 272 may support the bushing 212 along the second axis 160.

Because the second plurality of support members 272 may include a greater quantity of biasing members than the first plurality of support members 268, the second plurality of support members 272 may provide stiffer support for the bushing 212 than the first plurality of support members 268. Thus, the bushing 212 may be supported in the bearing 200 with a greater support stiffness along the second axis 160 than along the first axis 156. In addition, because the first plurality of support members 268 includes two biasing members 268a, 268b and the second plurality of support members 272 includes four biasing members 272a, 272b, 272c, 272d, the support stiffness along the second axis 160 may about two times greater than the support stiffness along the first axis 156. Thus, the bushing 212 may be supported anisotropically in the bearing 200.

FIG. 4B illustrates another embodiment of a bearing 300. The bearing 300 is similar to the bearing 200 described above with respect to FIG. 4A, and similar features are identified with similar reference numbers, plus 100. For example, the bearing 300 includes a bearing body 304, a bore 308 formed in the bearing body 304, a bushing 312 disposed in the bearing body 304, a first plurality of support members 368, and a second plurality of support members 372.

In contrast to the bearing 200, the bearing 300 may support the bushing 312 with a stiffness that is about 1.5 times greater along the first axis 156 than along the second axis 160. For example, the first plurality of support members 368 may include a first biasing member 368a, a second biasing member 368b, and a third biasing member 368c that are positioned on an opposing side of the bushing 312 with respect to the first axis 156 from a fourth biasing member 368d, a fifth biasing member 368e, and a sixth biasing member 368f. Further, the second plurality of support members 372 may include a seventh biasing member 372a and an eighth biasing member 372b that are positioned on an opposing side of the bushing 312 with respect to the second axis 160 from a ninth biasing member 372c and a tenth biasing member 372d. Thus, the first plurality of support members 368 may include a quantity of biasing members that is about 1.5 times greater than a quantity of biasing members of the second plurality of support members 372. As a result, the bearing 300 may support the bushing 312 with a support stiffness that is 1.5 times greater along the first axis 156 than along the second axis 160.

FIG. 4C illustrates another embodiment of a bearing 400. The bearing 400 is similar to the bearing 200 described above with respect to FIG. 4A, and similar features are identified with similar reference numbers, plus 200. For example, the bearing 400 includes a bearing body 404, a bore 408 formed in the bearing body 404, a bushing 412 disposed in the bore 408, a first plurality of support members 468, and a second plurality of support members 472.

However, in contrast to the bearing 200, the bearing 400 may support the bushing 412 with a stiffness that is about 3 times greater along the second axis 160 than along the first axis 156. For example, the first plurality of support members 468 may include a first biasing member 468a that is positioned on an opposing side of the bushing 412 with respect to the first axis 156 from a second biasing member 468b. Further, the second plurality of support members 472 may include a third biasing member 472a, a fourth biasing member 472b, and a fifth biasing member 472c that are positioned on an opposing side of the bushing 412 with respect to the second axis 160 from a sixth biasing member 472d, a seventh biasing member 272e, and an eighth biasing member 472f. Thus, the second plurality of support members 472 may include a quantity of biasing members that is about 3 times greater than a quantity of biasing members of the first plurality of support members 468. As a result, the bearing 400 may provide a support stiffness that is about 3 times greater along the second axis 160 than along the first axis 156.

Although not illustrated herein, it is to be recognized that other configurations of biasing members may be provided in other embodiments. For example, in some embodiments, the first plurality of support members and/or the second plurality of support members may include a different quantity of biasing members than the quantities illustrated herein. In one such embodiment, the first plurality of support members and the second plurality of support members may include the same quantity of biasing members as one another. In a further such embodiment, the biasing members of the first plurality of support members may have a different stiffness and/or may be sized differently than the biasing members of the second plurality of support members. Thus, the bushing may be supported anisotropically with the same quantity of biasing members providing support along the first axis and the second axis. In yet other embodiments, there may be additional pluralities of biasing members that support the bushing along additional axes other than the first axis and the second axis.

FIG. 5 illustrates another embodiment of a bearing 500 that provides anisotropic support. The bearing 500 is similar to the bearing 100 described above with respect to FIG. 3A, and similar features are identified with similar reference numbers, plus 400. For example, the bearing 500 may include a bearing body 504, a bore 508 formed in the bearing body 504, a bushing 512 disposed in the bore 508, and a plurality of support members 516. The plurality of support members 516 may provide support for the bushing 512 along the first axis 156, and the bearing body 504 may provide support for the bushing 512 along the second axis 160. In addition, the plurality of support members 516 may include a first biasing member 516a and a second biasing member 516b.

However, in contrast to the bearing 100, the first biasing member 516a and the second biasing member 516b may be provided as wave springs. As used herein, a wave spring may be understood to be a generally elongated body with at least one bend, curve, or wave formed in a length thereof. Further, the bends, curves, or waves of a wave spring may be selectively deformable. For example, the first biasing member 516a and the second biasing member 516b may be elongated and oriented parallel to the axis 50 (FIG. 2A), and the first biasing member 516a and the second biasing member 516b may each include at least one bend (not illustrated) that extends in a direction oriented radially inward with respect to the bushing 512. The bushing 512 may be in contact with the at least one bend, which may cause the at least one bend to deform (e.g., in a direction oriented radially outward with respect to the bushing 512). As a result, the first biasing member 516a and the second biasing member 516b may each apply a force to bushing 512 that is oriented radially inward with respect to the bushing 512. In particular, the forces applied to the bushing 512 by the first biasing member 516a and the second biasing member 516b may be oriented along the first axis 156 and oriented opposite to one another. Thus, the first biasing member 516a and the second biasing member 516b may support the bushing 512 along the first axis 156.

Although not specifically illustrated herein, it is to be recognized that wave springs may be used as biasing members in other embodiments of a bearing. For example, in some such embodiments, a bearing may include a first plurality of wave springs and a second plurality of wave springs (e.g., arranged similar to the biasing members in FIGS. 4A-4C) that support a bushing along a first axis and a second axis, respectively. Further, although not specifically illustrated herein, it is also to be recognized that other suitable alternatives may be used as biasing members in some other embodiments. For example, in one such embodiment, elastomeric blocks may be used as biasing members. In such embodiments, the elastomeric blocks may be composed of a material that retains at least one elastic property at a maximum expected temperature of the motor or a maximum expected temperature of the bearing. Further, the elastomeric blocks may be composed of a material having a suitable coefficient of thermal expansion for the bearing to accommodate the expansion and contraction of the elastomeric blocks.

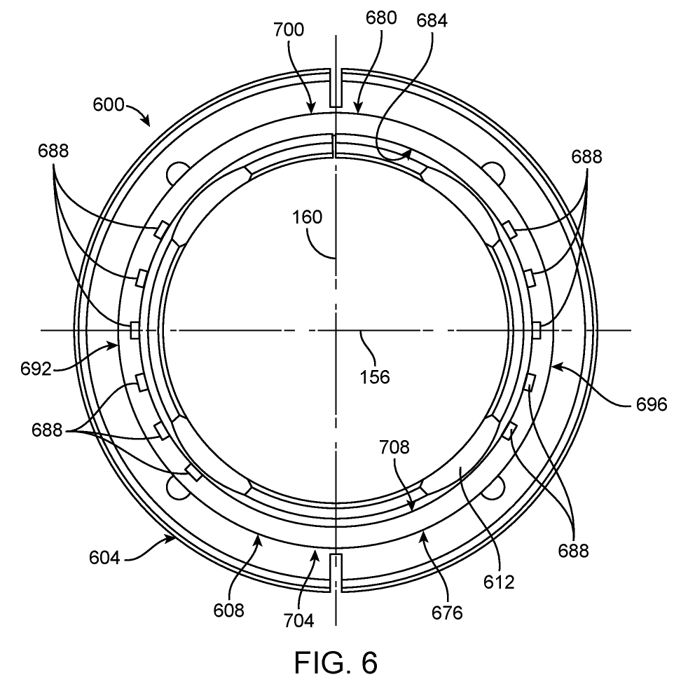

FIG. 6 illustrates another embodiment of a bearing 600 that provides anisotropic support. The bearing 600 is similar to the bearing 100 described above with respect to FIG. 3A, and similar features are identified with similar reference numbers, plus 500. For example, the bearing 600 includes a bearing body 604, a bore 608 formed in the bearing body 604, and a bushing 612 disposed in the bore 608.

However, in contrast to the bearing 100, the bearing 600 may include a cage 676 that supports the bushing 612 in the bearing body 604. The cage 676 may be a tubular-shaped structure that is disposed in the bore 608 and that supports the bushing 612 anisotropically. In particular, the cage 676 may include a ring-shaped cross section that extends along the axis 50 (FIG. 2A). The ring-shaped cross section may be defined by an outer cage diameter 680 and an inner cage diameter 684. The outer cage diameter 680 may be sized and shaped so the cage 676 may be disposed in the bore 608 (e.g., via a press-fit). The inner cage diameter 684 may be sized and shaped so the bushing 612 may be disposed in the cage 676. For example, the bushing 612 may abut or make contact with the inner cage diameter 684 when the bushing 612 is disposed in the cage 676. Further, the cage 676 may comprise a coefficient of the thermal expansion that is greater than a coefficient of thermal expansion of the bearing body 604 and less than a coefficient of thermal expansion of the bushing 612. Thus, even when the bearing 600 is subjected to a temperature change, the cage 676 may be retained in the bore 608, and the bushing 612 may be retained in the cage 676.

The cage 676 may further include a plurality of notches 688 that form one or more zones of reduced stiffness of the cage 676. In particular, the plurality of notches 688 may be formed proximate to a first region 692 and a second region 696 of the cage 676. The first region 692 may be positioned on an opposing side of the bushing 612 with respect to the first axis 156 from the second region 696. In contrast, the plurality of notches 688 may be absent from a third region 700 and a fourth region 704 of the cage 676. For example, each of the third region 700 and the fourth region 704 of the cage 676 may be positioned between the first region 692 and the second region 696. In addition, the third region 700 and the fourth region 704 may be positioned on opposing sides of the bushing 612 from one another with respect to the second axis 160.

The plurality of notches 688 may include a plurality of apertures or channels that are formed in the cage 676 and that reduce the stiffness of the cage 676. In particular, the plurality of notches 688 may be positioned adjacent to the inner cage diameter 684 and may extend toward the outer cage diameter 680. For example, in some embodiments, the plurality of notches may be formed by machining an inner surface 708 of the cage 676 before or after the cage 676 is disposed in the bushing 612. As a result, the cage 676 may have a reduced thickness proximate to each of the plurality of notches 688. Further, because the plurality of notches 688 are positioned in the first region 692 and the second region 696, at least a portion of the first region 692 and at least a portion of the second region 696 may have a reduced thickness compared to the third region 700 and the fourth region 704. As a result, it may be easier to deform the cage 676 proximate to the first region 692 and the second region 696 than proximate to the third region 700 and the fourth region 704. In addition, the plurality of notches 688 may reduce in size as the cage 676 is deformed. Thus, plurality of notches 688 may help to reduce the stiffness of the cage 676 proximate to the first region 692 and the second region 696. Therefore, a stiffness of the first region 692 and a stiffness of the second region 696 may be less than a stiffness of the third region 700 and a stiffness of the fourth region 704.

When the bushing 612 is disposed in the cage 676, the first region 692 and the second region 696 of the cage 676 may make contact with the bushing 612 to support the bushing 612 along the first axis 156. In contrast, the third region 700 and the fourth region 704 may make contact with the bushing 612 to support the bushing 612 along the second axis 160. Therefore, because the first region 692 and the second region 696 may have a reduced stiffness compared to the third region 700 and the fourth region 704, the cage 676 may provide a greater support stiffness along the second axis 160 than along the first axis 156. For example, in one exemplary embodiment, the support stiffness along the second axis 160 may be between about 1.0 times and about 100 times greater than the support stiffness along the first axis 156. In another exemplary embodiment, the support stiffness along the second axis 160 may be between about 3 times and about 100 times greater than the support stiffness along the first axis 156. In yet another embodiment, the support stiffness along the second axis 160 may be between about 4 times and about 100 times greater than the support stiffness along the second axis 160.

Although certain aspects have been described with reference to certain examples, it is to be recognized that variations and modifications exist within the spirit and scope of one or more independent aspects. Various features and aspects are set forth in the following claims.

What is claimed is:

1. A bearing comprising:
a bearing body having a bore extending therethrough;
a bushing positioned in the bore and supported by the bearing body, the bearing body providing a first support stiffness to support the bushing; and
a plurality of biasing members positioned in the bearing body, the plurality of biasing members being deformable to support the bushing with a second support stiffness that is different from the first support stiffness.

2. The bearing of claim 1, wherein the plurality of biasing members supports the bushing for rotation about a first axis, the bearing body supporting the bushing with respect to a second axis, wherein the first axis and the second axis are oriented non-parallel to one another.

3. The bearing of claim 1, further comprising a relief track positioned on the bearing body adjacent to the bore, wherein at least one of the plurality of biasing members is in contact with the bushing proximate to the relief track.

4. The bearing of claim 1, wherein the plurality of biasing members includes a plurality of wave springs, wherein each of the plurality of wave springs is selectively deformable in a radial direction with respect to the bushing.

5. The bearing of claim 1, wherein the plurality of biasing members includes a plurality of blocks composed of an elastomer, wherein each of the plurality of blocks is configured to retain an elastic property at a maximum expected temperature of the bearing.

6. The bearing of claim 1, wherein the plurality of biasing members includes a plurality of rolled spring pins, wherein each of the plurality of rolled spring pins is deformable with respect to a cross section thereof.

7. The bearing of claim 1, further comprising one or more keyways formed in the bearing body, wherein the one or more keyways are configured to engage with a stator to couple the bearing with the stator.

8. A bearing housing for supporting a bushing, the bearing housing comprising:
a bearing body including a bore extending therethrough along a bore axis, the bore configured to receive the bushing;
a first plurality of biasing members configured to support the bushing with a first support stiffness while the bushing is disposed in the bore, the first plurality of biasing members including a first biasing member and a second biasing member positioned on opposite sides of the bearing housing from one another, a first support axis extending between the first biasing member and the second biasing member, the first support axis oriented transversely with respect to the bore axis, the first biasing member and the second biasing member each configured to exert a force on the bushing that is directed radially inward with respect to the bore axis; and
a second plurality of biasing members configured to support the bushing with a second support stiffness greater than the first support stiffness while the bushing is disposed in the bore, the second plurality of biasing members including a third biasing member and a fourth biasing member positioned on opposite sides of the bearing housing from one another, a second support axis extending between the third biasing member and the fourth biasing member, the second support axis oriented transversely with respect to the bore axis and non-parallel to the first axis, the third biasing member and the fourth biasing member each configured to exert a force on the bushing that is directed radially inward with respect to the bore axis.

9. The bearing housing of claim 8, wherein the first plurality of biasing members includes a first quantity of biasing members, wherein the second plurality of biasing members includes a second quantity of biasing members that is greater than the first quantity of biasing members.

10. The bearing housing of claim 8, wherein the first plurality of biasing members includes a first quantity of biasing members, and wherein the second plurality of biasing members includes a second quantity of biasing members equal to the first quantity of biasing members, each of the first plurality of biasing members having a different stiffness than each of the second plurality of biasing members.

11. The bearing housing of claim 8, wherein the first axis and the second axis are oriented substantially perpendicular to one another.

12. The bearing housing of claim 8, wherein the first biasing member and the second biasing member are each positioned adjacent to the bore.

13. The bearing housing of claim 8, wherein the first support stiffness is about 1.5 times greater than the second support stiffness.

14. An electronic submersible pump system comprising:
a pump configured to displace a fluid;
a motor operably coupled to the pump to provide rotational power to the pump, the motor including:
an elongated motor casing,
a stator positioned in the elongated motor casing,
a rotor configured to rotate relative to the stator, and
a shaft coupled to the rotor and positioned at least partially in the elongated motor casing, the shaft rotating about a longitudinal axis; and
a bearing disposed in the elongated motor casing, the bearing configured to support the shaft as the shaft rotates relative to the stator, the bearing including:
a bearing body coupled to the stator;
a bushing disposed in the bearing body; and
a cage disposed in the bearing body, the cage including a plurality of notches that form at least one region of reduced stiffness of the cage, the cage supporting the bushing with a first support stiffness oriented along a first axis and a second support stiffness oriented along a second axis, the second support stiffness being less than the first support stiffness.

15. The electronic submersible pump system of claim 14, wherein the at least one region of reduced stiffness includes a first region of reduced stiffness and a second region of reduced stiffness, wherein the first region of reduced stiffness and the second region of reduced stiffness each provide support for the bearing along the second axis.

16. The electronic submersible pump system of claim 15, wherein the first region of reduced stiffness and the second region of reduced stiffness are positioned on opposing sides of the cage from one another.

17. The electronic submersible pump system of claim 14, wherein the cage includes an inner diameter and an outer diameter, and wherein each notch from the plurality of notches extends from the inner diameter toward the outer diameter.

18. The electronic submersible pump system of claim 17, wherein the bushing is positioned adjacent to the inner diameter.

19. The electronic submersible pump system of claim 14, wherein the first axis and the second axis are oriented transversely relative to the longitudinal axis of the shaft.

20. The electronic submersible pump system of claim 14, further comprising a sleeve disposed in the bushing and coupled with the shaft, the sleeve configured to rotate about the longitudinal axis with the shaft.
